(19) United States
(12) Patent Application Publication
(10) Pub. No.: US 2015/0218368 A1
(43) Pub. Date: Aug. 6, 2015

(54) POLYMER MIXTURES FOR THE PRODUCTION OF THIN-WALLED INJECTION MOLDED PARTS

(71) Applicant: BASF SE, Ludwigshafen (DE)

(72) Inventors: Martin Bussmann, Beindersheim (DE); Uwe Witt, Mutterstadt (DE); Jörg Kohl, Ludwigshafen (DE)

(21) Appl. No.: 14/422,902

(22) PCT Filed: Aug. 16, 2013
(86) PCT No.: PCT/EP2013/067102

§ 371 Date: Feb. 20, 2015

(30) Foreign Application Priority Data
Aug. 24, 2012 (EP) 12181699.5

(51) Int. Cl. C08L 67/04; B29C 45/00

(52) U.S. Cl. CPC C08L 67/04; B29C 45/0001; C08L 2205/02; B29K 2067/00

(57) ABSTRACT

The present invention relates to biodegradable polymer mixtures comprising:
A) from 15 to 50% by weight, based on components A and B, of a biodegradable, aliphatic-aromatic polyester with MFR (190° C./2.16 kg in accordance with ISO 1133) of from 40 to 150 g/10 min comprising:
   i) from 40 to 70 mol %, based on components i to ii, of one or more dicarboxylic acid derivatives or dicarboxylic acids selected from the group consisting of: succinic acid, adipic acid, sebacic acid, azelaic acid, and brassylic acid;
   ii) from 60 to 30 mol %, based on components i to ii, of a terephthalic acid derivative;
   iii) from 98 to 100 mol %, based on components i to ii, of a C₂-C₈-alkylenediol or C₂-C₆-oxyalkylenediol;
   iv) from 0 to 2% by weight, based on the total weight of components i to iii, of a chain extender and/or branching agent selected from the group consisting of: a di- or polyfunctional isocyanate, isocyanurate, oxazoline, epoxide, and carboxylic anhydride, and/or of an at least trihydric alcohol, or of an at least tribasic carboxylic acid;
B) from 50 to 85% by weight, based on components A and B, of polylactic acid with MFR (190° C./2.16 kg in accordance with ASTM D1238) of from 5 to 50 g/10 min,
C) from 0 to 40% by weight, based on the total weight of components A to D, of an organic filler, and
D) from 0 to 3% by weight, based on the total weight of components A to D, of at least one stabilizer, nucleating agent, lubricant and release agent, surfactant, wax, antistatic agent, antifogging agent, dye, pigment, UV absorber, UV stabilizer, or other plastics additive;
   for producing thin-walled injection-molded components.

### DESCRIPTION

The present invention relates to biodegradable polymer mixtures comprising:
A) from 15 to 50% by weight, based on components A and B, of a biodegradable, aliphatic-aromatic polyester with MFR (190° C./2.16 kg in accordance with ISO 1133) of from 40 to 150 g/10 min comprising:
   i) from 40 to 70 mol %, based on components i to ii, of one or more dicarboxylic acid derivatives or dicarboxylic acids selected from the group consisting of: succinic acid, adipic acid, sebacic acid, azelaic acid, and brassylic acid;
   ii) from 60 to 30 mol %, based on components i to ii, of a terephthalic acid derivative;

iii) from 98 to 100 mol %, based on components i to ii, of a C₂-C₈-alkylenediol or C₂-C₆-oxyalkylenediol;
iv) from 0 to 2% by weight, based on the total weight of components i to iii, of a chain extender and/or branching agent selected from the group consisting of: a di- or polyfunctional isocyanate, isocyanurate, oxazoline, epoxide, and carboxylic anhydride, and/or of an at least trihydric alcohol, or of an at least tribasic carboxylic acid;
B) from 50 to 85% by weight, based on components A and B, of polylactic acid with MFR (190° C./2.16 kg in accordance with ASTM D1238) of from 5 to 50 g/10 min,
C) from 0 to 40% by weight, based on the total weight of components A to D, of an organic filler selected from the group consisting of: native or plastified starch, natural fibers, and wood flour, and/or of an inorganic filler selected from the group consisting of: chalk, calcium carbonate, graphite, gypsum, conductive carbon black, iron oxide, calcium chloride, dolomite, kaolin, silicon dioxide (quartz), sodium carbonate, titanium dioxide, silicate, wollastonite, mica, montmorillonite, talc powder, glass fibers, and mineral fibers, and
D) from 0 to 3% by weight, based on the total weight of components A to D, of at least one stabilizer, nucleating agent, lubricant and release agent, surfactant, wax, antistatic agent, antifogging agent, dye, pigment, UV absorber, UV stabilizer, or other plastics additive;
   for producing thin-walled injection-molded components.

WO 2006/074815 discloses the use of biodegradable polymer mixtures comprising aliphatic/aromatic polyesters A and polylactic acid B for producing injection-molded items and blown films. The mixtures of WO 2006/074815 differ in particular from the present mixtures in the MFR of polymer component A used. WO 2006/074815 uses branched and/or chain-extended polyesters with MFR of less than 10 cm³/10 min. These polymer mixtures are not very suitable for thin-wall injection molding because of their flow properties.

It was therefore an object of the present invention to provide polymer mixtures which are suitable for thin-wall injection molding and which give injection-molded items with good mechanical properties. A particular feature of a free-flowing polymer for injection-molding applications is that a flow path/wall thickness ratio of at least 200 is achieved in the flow spiral test. Flow path lengths of at least 200 mm can be achieved with 1 mm spiral thickness.

Surprisingly, an item produced by thin-wall injection molding and comprising:
A) from 15 to 50% by weight, based on components A and B, of a biodegradable, aliphatic-aromatic polyester with MFR (190° C./2.16 kg in accordance with ISO 1133) of from 40 to 150 g/10 min comprising:
   i) from 40 to 70 mol %, based on components i to ii, of one or more dicarboxylic acid derivatives or dicarboxylic acids selected from the group consisting of: succinic acid, adipic acid, sebacic acid, azelaic acid, and brassylic acid;
   ii) from 60 to 30 mol %, based on components i to ii, of a terephthalic acid derivative;
   iii) from 98 to 100 mol %, based on components i to ii, of a C₂-C₈alkylenediol or C₂-C₆-oxyalkylenediol;
   iv) from 0 to 2% by weight, based on the total weight of components i to iii, of a chain extender and/or branching agent selected from the group consisting of: a di- or polyfunctional isocyanate, isocyanurate, oxazoline, epoxide, and carboxylic anhydride, and/or of an at least trihydric alcohol, or of an at least tribasic carboxylic acid;
B) from 50 to 85% by weight, based on components A and B, of polylactic acid with MFR (190° C./2.16 kg in accordance with ASTM D1238) of from 5 to 50 g/10 min,
C) from 0 to 40% by weight, based on the total weight of components A to D, of an organic filler selected from the group consisting of: native or plastified starch, natural fibers, and wood flour, and/or of an inorganic filler selected from the group consisting of: chalk, calcium carbonate, graphite, gypsum, conductive carbon black, iron oxide, calcium chloride, dolomite, kaolin, silicon dioxide (quartz), sodium carbonate, titanium dioxide, silicate, wollastonite, mica, montmorillonite, talc powder, glass fibers, and mineral fibers, and
D) from 0 to 3% by weight, based on the total weight of components A to D, of at least one stabilizer, nucleating agent, lubricant and release agent, surfactant, wax, antistatic agent, antifogging agent, dye, pigments, UV absorber, UV stabilizer, or other plastics additive;
   has not only optimized mechanical properties but also optimized heat resistance and optimized biodegradability.

Components A and B are in particular responsible for the required flow performance and the interesting property profile of the item.

The invention is described in more detail below.

The production of the aliphatic-aromatic polyesters A suitable for the invention is described in more detail by way of example in WO 2009/127555, which is expressly incorporated herein by way of reference.

Polyesters A are generally composed of the following:
i) from 40 to 70 mol %, based on components i to ii, of one or more dicarboxylic acid derivatives or dicarboxylic acids selected from the group consisting of: succinic acid, adipic acid, sebacic acid, azelaic acid, and brassylic acid;
ii) from 60 to 30 mol %, based on components i to ii, of a terephthalic acid derivative;
iii) from 98 to 100 mol %, based on components i to ii, of a C₂-C₈-alkylenediol or C₂-C₆-oxyalkylenediol;
iv) from 0 to 2% by weight, based on the total weight of components i to iii, of a chain extender and/or branching agent selected from the group consisting of: a di- or polyfunctional isocyanate, isocyanurate, oxazoline, epoxide, and carboxylic anhydride, and/or of an at least trihydric alcohol, or of an at least tribasic carboxylic acid; preferably from 0.01 to 1.5% by weight of an at least trihydric alcohol.

The copolyesters described are preferably synthesized in a direct polycondensation reaction of the individual components. The dicarboxylic acid derivatives here are reacted directly together with the diol in the presence of a transesterification catalyst to give the polycondensate of the desired molecular weight. On the other hand, it is also possible to obtain the polyester via transesterification of, for example, polybutylene succinate (PBS) with C₈-C₂₀ dicarboxylic acids in the presence of diol. Catalysts usually used comprise zinc catalysts, aluminum catalysts, and in particular titanium catalysts. An advantage of titanium catalysts, such as tetra(isopropyl)orthotitanate and in particular tetraisobutoxy titanate (TBOT) is that, when compared with the tin catalysts, antimony catalysts, cobalt catalysts, and lead catalysts often used in the literature, for example tin dioctanoate, residual amounts of the catalyst or downstream product from the catalyst remaining in the product are less toxic.

Preference is given to a process for the continuous production of component A, where a mixture of the aliphatic dihydroxy compounds, and of the aliphatic and aromatic dicarboxylic acids are mixed to give a paste, without addition of any catalyst, or, as an alternative, the liquid esters of the dicarboxylic acids and the dihydroxy compound and optionally other comonomers are fed into the mixture, without addition of any catalyst, where
1) this mixture, together with the total amount or a partial amount of a titanium catalyst, is continuously esterified or, respectively, transesterified;
2) the transesterification or esterification product obtained in 1) is continuously precondensed in a tower reactor and in cocurrent mode by way of a falling-film evaporator, where the reaction vapors are removed in situ from the reaction mixture, until an intrinsic viscosity in accordance with DIN 53728 of from 30 to 80 cm³/g is reached;
3) the product obtainable from 2) is continuously polycondensed until an intrinsic viscosity in accordance with DIN 53728 of from 40 to 150 cm³/g is reached.

The MFR (melt volume rate after stage 3; 190° C./2.16 kg in accordance with ISO1133) is from 40 to 150 g/10 min, and preferably from 60 to 110 g/10 min. The high values (for the low-viscosity liquid polyester A) can be determined more precisely at 170° C. The MFR (melt volume rate after stage 3; 170° C./2.16 kg in accordance with ISO1133) is then from 30 to 120 g/10 min, and preferably from 50 to 90 g/10 min.

Diols iii) that can be used are a C₂-C₈-alkylenediol or C₂-C₈-oxyalkylenediol. The diols are preferably 1,3-propanediol and 1,4-butanediol, which are obtainable from renewable raw materials. It is also possible to use a mixture of the two diols. 1,4-Butanediol is preferred as diol because of the higher melting points and the better crystallization of the resultant copolymer.

At the start of the polymerization reaction, the ratio established of the diol (component C) to the acids (components A and B) is generally (diol:diacids) from 1.0 to 2.5:1 and preferably from 1.3 to 2.2:1. Excessive amounts of diol are drawn off during the polymerization reaction in such a way as to establish an approximately equimolar ratio at the end of the polymerization reaction. The expression approximately equimolar means a diol/diacid ratio of from 0.90 to 1.

It is preferable to use from 0.05 to 1.5% by weight, in particular from 0.1 to 0.9% by weight, and particularly from 0.1 to 0.8% by weight, based on the total weight of components A to B, of a branching agent, preferably of at least one trihydric alcohol, or of at least one tribasic carboxylic acid.

The number-average molar mass (Mn) of the polyesters A is generally in the range from 5000 to 20 000 g/mol, in particular in the range from 10 000 to 15 000 g/mol, and their weight-average molar mass (Mw) is generally from 10 000 to 100 000 g/mol, preferably from 20 000 to 30 000 g/mol, and their Mw/Mn ratio is generally from 1 to 6, preferably from 2 to 4.

Polylactic acid (PLA) is used as stiff component B.

It is preferable to use polylactic acid with the following property profile:
a melt volume rate (MFR for 190° C. and 2.16 kg in accordance with ASTM D1238) of from 5 to 50 ml/10 minutes, in particular from 10 to 40 ml/10 minutes
a melting point below 240° C.
a glass transition temperature (Tg) above 55° C.
a water content smaller than 1000 ppm
a residual monomer content (lactide) smaller than 0.3%
a molecular weight greater than 80 000 daltons.

Examples of preferred polylactic acids are Ingeo® 3051 D, and in particular Ingeo® 3251 D from NatureWorks.

Polylactic acid B is used in a percentage proportion by weight, based on components A and B, of from 50 to 85%, preferably from 55 to 80%, and with particular preference from 60 to 75%. It is preferable here that the polylactic acid B forms the continuous phase or is part of a cocontinuous phase, and that the polyester A forms the disperse phase.

From 10 to 50% by weight, in particular from 10 to 40% by weight, and particularly preferably from 10 to 35% by weight, based on the total weight of components A to D, of at least one mineral filler are generally used, selected from the group consisting of: chalk, graphite, gypsum, conductive carbon black, iron oxide, calcium chloride, dolomite, kaolin, silicon dioxide (quartz), sodium carbonate, titanium dioxide, silicate, wollastonite, mica, montmorillonite, talc powder, and mineral fibers.

Particular preference is given to chalk (calcium carbonate) and talc powder (magnesium silicate) as fillers. Interestingly, it has been found that addition of chalk can improve the biodegradability of the items further. Heat resistance can be improved and modulus of elasticity can be increased more effectively in turn by using talc powder.

Mixtures of chalk and talc powder have proven to be particularly advantageous. A mixing ratio that has proven to be advantageous here (chalk:talc powder) is from 2:5 to 5:1, preferably from 1:1 to 3:1.

For the purposes of the present invention, a substance or a substance mixture has the “biodegradable” feature if said substance or the substance mixture exhibits a percentage degree of biodegradation of at least 90% after 180 days in accordance with DIN EN 13432.

Biodegradability generally means that the polyesters (polyester mixtures) decompose within an appropriate and demonstrable period of time. The degradation can take place enzymatically, hydrolytically, oxidatively, and/or via exposure to electromagnetic radiation, for example UV radiation, and can mostly be brought about predominantly via exposure to microorganisms, such as bacteria, yeasts, fungi, and algae. Biodegradability can by way of example be quantified by mixing polyester with compost and storing it for a defined time. By way of example, in accordance with DIN EN 13432 (with reference to ISO 14855), CO₂-free air is passed through ripened compost during the composting process, and the compost is subjected to a defined temperature profile. Biodegradability is defined here as a percentage degree of biodegradation, by taking the ratio of the net amount of CO₂ released from the specimen (after subtraction of the amount of CO₂ released by the compost without specimen) to the maximum amount of CO₂ that can be released from the specimen (calculated from the carbon content of the specimen). Biodegradable polyesters (polyester mixtures) generally exhibit marked signs of degradation after just a few days of composting, examples being fungal growth, cracking, and perforation.

Other methods for determining biodegradability are described by way of example in ASTM D5338 and ASTM D6400-4.

Thin-wall injection molding can produce moldings with wall thicknesses smaller than 1 mm or indeed smaller than 0.5 mm. The average wall thickness of the moldings produced by thin-wall injection molding is generally from 0.3 to 0.8 mm, and preferably from 0.4 to 0.7 mm. This process is therefore of interest in providing access to thin-walled injection-molded items in particular in the packaging sector. Consideration may be given here in particular to injection-molded items with wall thickness from 0.3 to 0.8 mm comprising the polymer mixtures according to the invention, examples being cups, pots, vessels, buckets, containers—for example for dairy products, and also trays—optionally inclusive of lids—for frozen products, ice cream, sausage products, meat, and fruit.

Thin-wall injection molding using materials such as polypropylene is described in detail by way of example in Plastverarbeiter 55 (2004), pp. 24 ff and Plastverarbeiter 53 (2002), pp. 28 ff. However, polypropylene has the disadvantage of not being biodegradable.

Performance Tests:

The molecular weights Mn and Mw of the semiaromatic polyesters were determined in accordance with DIN 55672-1, by means of SEC: eluant hexafluoroisopropanol (HFIP)+0.05% by weight of Ka trifluoroacetic acetate; narrowly distributed polymethyl methacrylate standards were used for calibration.

Intrinsic viscosities were determined in accordance with DIN 53728 part 3, Jan. 3, 1985, Capillary viscometry. A micro-Ubbelohde viscometer of type M-II was used. A mixture of phenol/o-dichlorobenzene in a ratio by weight of 50/50 was used as solvent.

Modulus of elasticity was determined by means of a tensile test on injection-molded dumbbell specimens in accordance with ISO 527.

Charpy impact resistance was determined in accordance with ISO 179-2/1eU:1997. The test specimen (80 mm×10 mm×4 mm), in the form of a horizontal bar supported close to its ends, is subjected to a single impact of a pendulum, where the impact line is in the center between the two supports, and a high, nominally constant (specimen) bending velocity (2.9 or 3.8 m/s) is used.

The degradation rates of the biodegradable polyester mixtures and of the mixtures produced for comparison were determined as follows:

Films of thickness 400 μm were produced from each of the biodegradable polyester mixtures and each of the mixtures produced for comparison, by pressing at 190° C. Said films were cut into rectangular sections with edge lengths of 2×5 cm. The weight of these film sections was determined. The film sections were heated to 58° C. for four weeks in a drying oven in a plastics container containing moistened compost. At weekly intervals, the remaining weight of the film sections was measured. On the assumption that biodegradation can be considered in these instances to be purely a surface process, the gradient of the resultant weight reduction (biodegradation rate) was determined by calculating the difference between the weight measured after taking of a specimen and the mass of the film before the start of the test, less the average total weight reduction that occurred up to the taking of the preceding specimen. The mass reduction obtained was also standardized for surface area (in cm²) and also for time between taking of current and previous specimen (in d).

Starting Materials

Polyester Component A:

A1: Polybutylene adipate-co-terephthalate (adipic acid:terephthalic acid=53:47 mol %)
MFR (190° C./2.16 kg in accordance with ISO 1133)=from 129-130 g/10 min
MFR (170° C./2.16 kg in accordance with ISO 1133)=from 83-84.5 g/10 min

A2: Polybutylene adipate-co-terephthalate (adipic acid:terephthalic acid=53:47 mol %) (comparative system)
MFR (190° C./2.16 kg in accordance with ISO 1133)=2.5-4.5 g/10 min

Polylactic Acid B

B1: NatureWorks Ingeo® 3251D: MFR (190° C./2.16 kg in accordance with ASTM D1238)=from 35 g/10 min

Filler C

C1: Mikrotalc IT Extra

Lubricant D

D1: Erucamide

To determine biodegradability, films of thickness about 420 μm were produced by means of a molding press.

### EXAMPLES

I) Production of the polymer mixtures of inventive example 1 (1) and of comparative example 2 (comp.-2)—general specification

The compounded materials listed in table 1 were manufactured in a Coperion ZSB 40 extruder. The discharge temperatures were set to 250° C. The extrudate was then pelletized under water.

TABLE 1
Compounded materials produced

| | Polyester | Polyester A2 | | | |
|---|---|---|---|---|---|
| Compounded | A1 | (comparison) | PLA B1 | Filler C1 | Lubricant D1 |
| materials | [% by wt.*] | [% by wt.*] | [% by wt.*] | [% by wt.**] | [% by wt.**] |
| 1 | 26.0 | | 74.0 | 15 | 0.5 |
| comp.-2 | | 26.0 | 74.0 | 15 | 0.5 |

*based on components A and B
**based on components A to D

II) Production of the Moldings

Both materials were processed in a Synergy 1200-230 injection-molding machine with screw diameter 32.00 mm. The injection mold was a single-cavity mold with open hot runner. A pot was manufactured with wall thickness 0.7 and 0.5 mm and flow path length 85 mm (i=120 for 0.7 mm and i=168 for 0.5 mm).

Experiment II-a: Pot with wall thickness 0.7 mm:

When material comp.-2 was used (see table 1) with optimized production parameters the injection pressure required by the machine was 1700 bar. When the same production parameters were used with the material 1 (see table 1) it was possible to lower the injection pressure to 1400 bar. The experiment with material comp.-2 was also run with a method that restricted the injection pressure to 1400 bar, the value for the material 1. The mold fill factor was found here to be only 80.1% (see table 2).

Experiment II-b: Pot with wall thickness 0.5 mm:

This experiment used the abovementioned pot geometry but with internal wall thickness reduction from 0.7 to 0.5 mm. There were no changes to the machine or to the remainder of the experimental setup.

Results with the material comp.-2 were similar to those of experiment Il-a: the best injection pressure for producing this geometry with the material comp.-2 was 1700 bar. However, when the same production parameters were used with material 1 it was possible to lower the injection pressure to 1400 bar. By analogy with experiment II-a, the experiment with material comp.-2 was run with a method that restricted the injection pressure to 1400 bar, i.e. the value for the material 1. The mold fill factor was found here to be only 65.7%.

III) Flow Spiral Test

Filling of the mold is always dependent on the flow performance of the melt. Flow performance at a defined temperature can be assessed by using a spiral mold in a commercially available injection-molding machine. The distance traveled by the melt in this mold is a measure of flow performance.

Table 2 lists the spiral lengths for 1 and comp.-2. Injection pressure and hold pressure were restricted to at most 1000 bar. Hold pressure time was restricted to 5 sec. Injection volume flow rate was selected to be 50 [cm³/s]. The temperatures set throughout the experiments were: mold surfaces 30° C. and melt temperature 205° C. The maximum flow performance of a thermoplastic is characterized in this test where the achievable spiral length is a function of spiral thickness. This gives the flow distance:wall thickness ratio. Thinner spirals give smaller flow distance:wall thickness ratios. Table 2 lists these numeric ratios (i) for spirals of thickness 0.7 and 0.5 mm.

TABLE 2
Flow spiral test results and mechanical data for 1 and comp.-2

Example

| | | comp.-2 |
|---|---|---|
| | 1 | (Comparison) |
| Experiment II-a | | |
| Flow path length [mm] | 141 | 106 |
| Flow distance: wall thickness ratio | i = 176.3 | i = 132.5 |
| (i) for 0.7 mm | | |
| Experiment II-b | | |
| Flow path length [mm] | 61 | 42 |
| Flow distance: wall thickness ratio | i = 122 | i = 82 |
| (i) for 0.5 mm | | |
| MFR of mixture (190° C., 2.16 kg) | 34.6 | 9.8 |
| Modulus of elasticity [MPa] | 2697 | 2818 |
| Charpy impact resistance | 44.5 | 45.7 |
| measured on dumbbell specimen | | |
| at 23° C., a_{N} in accordance with | | |
| ISO 179/1 eU | | |

1. A flowable polymer mixture comprising:
(A) from 15 to 50% by weight, based on components A and B, of a biodegradable, aliphatic-aromatic polyester with MFR (190° C./2.16 kg in accordance with ISO 1133) of from 40 to 150 g/10 min comprising:
i. from 40 to 70 mol %, based on components i to ii, of one or more dicarboxylic acid derivatives or dicarboxylic acids selected from the group consisting of succinic acid, adipic acid, sebacic acid, azelaic acid, and brassylic acid;
ii. from 60 to 30 mol %, based on components i to ii, of a terephthalic acid derivative;
iii. from 98 to 100 mol %, based on components i to ii, of a C₂-C₈-alkylenediol or C₂-C₆-oxyalkylenediol;
iv. from 0 to 2% by weight, based on the total weight of components i to iii, of a chain extender and/or branching agent selected from the group consisting of: a di- or polyfunctional isocyanate, isocyanurate, oxazoline, epoxide, and carboxylic anhydride, and/or of an at least trihydric alcohol, or of an at least tribasic carboxylic acid;
(B) from 50 to 85% by weight, based on components A and B, of polylactic acid with MFR (190° C./2.16 kg in accordance with ASTM D1238) of from 5 to 50 g/10 min,
(C) from 0 to 40% by weight, based on the total weight of components A to D, of an organic filler selected from the group consisting of: native or plastified starch, natural fibers, and wood flour, and/or of an inorganic filler selected from the group consisting of: chalk, calcium carbonate, graphite, gypsum, conductive carbon black, iron oxide, calcium chloride, dolomite, kaolin, silicon dioxide (quartz), sodium carbonate, titanium dioxide, silicate, wollastonite, mica, montmorillonite, talc powder, glass fibers, and mineral fibers, and
(D) from 0 to 3% by weight, based on the total weight of components A to D, of at least one stabilizer, nucleating agent, lubricant and release agent, surfactant, wax, antistatic agent, antifogging agent, dye, pigment, UV absorber, UV stabilizer, or other plastics additive.

2. The polymer mixture according to claim 1, where the definitions of components i) and ii) of the polyester A are as follows:
i. from 52 to 65 mol %, based on components i to ii, of adipic acid and/or of sebacic acid derivatives;
ii. from 48 to 35 mol %, based on components i to ii, of a terephthalic acid derivative.

3-6. (canceled)

7. The polymer mixture according to claim 1, where component iv of A includes the trihydric alcohol present from 0.01 to 1.5% by weight.

8. The polymer mixture according to claim 2, where component iv of A includes the trihydric alcohol present from 0.01 to 1.5% by weight.

9. The polymer mixture according to claim 1, where filler C includes the calcium carbonate and or the chalk present from 5 to 30% by weight.

10. The polymer mixture according to claim 8, where filler C includes the calcium carbonate and or the chalk present from 5 to 30% by weight.

11. The polymer mixture according to claim 8, where component iii of A includes 1,3-propanediol, 1,4-butanediol or a mixture thereof.

12. The polymer mixture according to claim 1, where the polylactic acid is further characterized by a melting point below 240° C., and a glass transition temperature above 55° C.

13. The polymer mixture according to claim 9, where filler C further include talc, where a weight ratio of chalk:talc is from 2:5 to 5:1.

14. An injection-molded item with wall thickness from 0.3 to 0.8 mm comprising the polymer mixture according to claim 1.

15. An injection-molding process for the production of packaging material with wall thickness from 0.3 to 0.8 mm comprising the polymer mixture according to claim 1.
